(19) United States
(12) Patent Application Publication
(10) Pub. No.: US 2026/0233727 A1
(43) Pub. Date: Aug. 13, 2026

(54) DRIVING METHOD IN CASE OF MOTOR FAILURE

(71) Applicants: HYUNDAI MOTOR COMPANY, Seoul (KR); Kia Corporation, Seoul (KR)

(72) Inventors: Jeong-Won RHO, Hwaseong-si (KR); Tae-Jin KIM, Hwaseong-si (KR); Sang-Cheol PARK, Hwaseong-si (KR)

(21) Appl. No.: 19/275,722

(22) Filed: Jul. 21, 2025

(30) Foreign Application Priority Data
Feb. 13, 2025 (KR) 10-2025-0018759

(51) Int. Cl. B60W 20/50; B60K 6/26; B60K 6/46; B60W 20/13; H02J 7/14; H02P 5/74

(52) U.S. Cl. CPC B60W 20/50; B60W 20/13; H02J 7/1476; H02P 5/74; B60K 6/26; B60K 2006/268; B60K 6/46; B60W 2510/081; B60W 2510/087; B60W 2510/244; B60W 2510/248; B60W 2540/10; B60W 2710/0627; B60W 2710/0666; B60W 2710/083; B60W 2710/244; B60Y 2200/92; B60Y 2300/67

(57) ABSTRACT

A driving method of a vehicle in a motor failure includes determining, by a vehicle controller, whether a failure occurs in a motor among a plurality of motors or in an inverter connected to the motor, based on determination of the failure, switching, by the vehicle controller, to a limp-home mode in which the vehicle operates using an engine and a remaining motor among the plurality of the motors, and executing, by the vehicle controller, one of a plurality of cooperative control operation schemes or the plurality of cooperative control operation schemes sequentially based on battery state information obtained from a battery management system (BMS).

### CROSS-REFERENCE TO RELATED APPLICATION

This application claims priority to Korean Patent Application No. 10-2025-0018759, filed on Feb. 13, 2025, which is incorporated herein by reference in its entirety.

### TECHNICAL FIELD

The present disclosure relates to vehicle driving technology.

### BACKGROUND

In a (P)HEV (hybrid electric vehicle) system for an eco-friendly vehicle, in case of a drive motor failure, a high-voltage main relay may be turned off, and limp-home driving may be performed using an engine. In this case, a power electric (PE) component such as a low-voltage DC-DC converter (LDC) or an oil pump control unit (OPU) may operate using back electromotive force of a P0 motor (Hybrid Starter Generator, HSG) connected to the engine through a belt.

In contrast to a P0+P2 (P)HEV system, a P1+P2 (P)HEV system may allow a P1 motor to be used not only for engine cranking but also as a drive motor. In some cases, the P1 motor may not be used as a standalone drive motor, but can be coupled to the engine to assist with drive force of the engine in vehicle operation.

In some cases, a failure in the P1+P2 (P)HEV system refers to a case where normal output may not be generated due to a failure in the a P2 motor or in an inverter that controls the P2 motor. Examples of the failure include over-temperature failure, position sensor failure, temperature sensor failure, or the like.

In the P1+P2 (P)HEV system, in case of a P2 motor failure, the high-voltage main relay is turned off, and back electromotive force of the P1 motor, which rotates along with the engine, is used to operate an electrical load such as the LDC or the OPU. In addition, the operation is performed using engine output alone for vehicle driving.

This is referred to as engine limp-home driving, which can operate the electrical load within a limited output range (limited by the back electromotive force of the P1 motor).

For example, in the engine limp-home driving, the vehicle may start by slipping an engine clutch, resulting in reduced hill-climbing performance. The reason for turning off the main relay in case of a P2 motor failure is that back electromotive force of the faulty motor can directly flow into the battery, potentially causing overcharging of the main battery.

In some cases, if the overcharging issue is resolved, the engine limp-home driving may be performed with the main relay kept turned on, even in case of the P2 motor failure. In particular, in the P1+P2 (P)HEV system, the P1 motor may be also capable of assisting with drive force, potentially enhancing performance of the vehicle.

### SUMMARY

The present disclosure describes a driving method, which can prevent overcharging of a main battery during limp-home driving, while the main relay remains turned on and is not turned off in case of a P2 motor failure.

The present disclosure further describes a driving method, which enables driving while using the main battery and a P1 motor.

The present disclosure further describes a driving method, which can prevent overcharging of a main battery during limp-home driving, while the main relay remains turned on and is not turned off in case of a P2 motor failure.

According to one aspect of the subject matter described in this application, a driving method operates a vehicle in a motor failure, where the vehicle includes first and second motors that are arranged in parallel with each other. The driving method includes determining, by a vehicle controller, whether a failure has occurred in the second motor or in an inverter connected to the second motor, based on a determination of the failure in the second motor or the inverter, switching, by the vehicle controller, to a limp-home mode in which the vehicle operates using an engine of the vehicle and the first motor that is directly connected to the engine, and executing, by the vehicle controller, at least one of a plurality of cooperative control operation schemes based on battery state information obtained from a battery management system (BMS).

Implementations according to this aspect can include one or more of the following features. For example, the battery state information can include at least one of a state of charge (SOC), a state of health (SOH), a depth of discharging (DOD), or a state of function (SOF). In some examples, the failure in the second motor or the inverter can include at least one of an over-temperature failure, a position sensor failure, or a temperature sensor failure.

In some implementations, the plurality of cooperative control operation schemes can include a first-stage cooperative control operation scheme that includes charging a battery of the vehicle by back electromotive force of the second motor based on main relay state information indicating that a main relay of the vehicle is turned on, comparing a charge level included in the battery state information with a preset first threshold, and based on the charge level being greater than the preset first threshold, executing, by the BMS, a battery charging limit process.

In some examples, the first-stage cooperative control operation scheme further can include, after executing the battery charging limit process, determining, by the vehicle controller, (i) whether a charging current is greater than a preset reference current and (ii) whether an increase of the charge level in the battery state information is greater than a preset increment value, and based on determining that the charging current is greater than the preset reference current and that the increase of the charge level is greater than the preset increment value, distributing, by the vehicle controller, power to the first motor and the engine according to a driver demand torque.

In some examples, distributing the power to the first motor and the engine can include providing (i) a first portion of the power to the first motor to operate the first motor with a maximum torque that is set to prevent overcharging of the battery and (ii) a second portion of the power to the engine to operate the engine with a supplemental torque to thereby provide a remainder of the driver demand torque.

In some implementations, the plurality of cooperative control operation schemes can include a second-stage cooperative control operation scheme that includes charging a battery of the vehicle by back electromotive force of the second motor, determining whether a first overcharging condition is satisfied based on the battery state information and main relay state information of a main relay of the vehicle, based on determining that the first overcharging condition is satisfied, determining whether a second overcharging condition is satisfied based on motor state information indicating that the second motor is uncontrollable, and based on determining that the second overcharging condition is satisfied, performing, by the vehicle controller, at least one of a shift intervention control or a fuel cut control.

In some examples, the first overcharging condition is satisfied based on (i) a charge level included in the battery state information being greater than a preset second threshold and (ii) the main relay being turned on. In some examples, the shift intervention control can include transmitting, by the vehicle controller, an estimated accelerator position sensor (APS) signal to a transmission controller. For example, the estimated APS signal can be set to 20-30% of a reference APS signal corresponding to a maximum accelerator position.

In some implementations, the fuel cut control can include determining, by the vehicle controller, whether an engine speed obtained from an engine controller is greater than a preset speed threshold, and based on determining that the engine speed is greater than the preset speed threshold, performing, by the engine controller, the fuel cut control.

In some implementations, the plurality of cooperative control operation schemes can include a third-stage cooperative control operation scheme that includes charging a battery of the vehicle by back electromotive force of the second motor based on main relay state information indicating that a main relay of the vehicle is turned on, comparing a charge level included in the battery state information with a preset third threshold, and based on the charge level being greater than the preset third threshold, switching to an engine limp-home driving mode in which the vehicle operates using the engine alone.

In some examples, switching to the engine limp-home driving mode can include performing, by the vehicle controller, a startup of the engine, and then transmitting, by the vehicle controller, to the BMS, a request message to turn off the main relay. For example, the startup of the engine can be performed using the first motor.

According to another aspect of the subject matter described in this application, a driving method operates a vehicle in a motor failure, where the vehicle includes first and second motors that are arranged in parallel with each other. The driving method includes determining, by a vehicle controller, whether a failure has occurred in the first motor or in an inverter connected to the first motor, based on determination of the failure in the first motor or the inverter, switching, by the vehicle controller, to a limp-home mode in which the vehicle operates using an engine of the vehicle and the second motor, wherein the second motor is connected to the engine and located farther from the engine than the first motor is, and executing, by the vehicle controller, at least one of a second-stage cooperative control operation scheme or a third-stage cooperative control operation scheme based on battery state information obtained from a battery management system (BMS).

Implementations according to this aspect can include one or more of the following features. For example, the second-stage cooperative control operation scheme can include charging a battery of the vehicle by back electromotive force of the first motor, determining whether a first overcharging condition is satisfied based on the battery state information and main relay state information of a main relay of the vehicle, based on determining that the first overcharging condition is satisfied, determining whether a second overcharging condition is satisfied based on motor state information indicating that the first motor is uncontrollable, and based on determining that the second overcharging condition is satisfied, performing, by the vehicle controller, a shift intervention control.

In some examples, the third-stage cooperative control operation scheme can include charging a battery of the vehicle by back electromotive force of the first motor based on main relay state information indicating that a main relay of the vehicle is turned on comparing a charge level included in the battery state information with a preset third threshold, and based on the charge level being greater than the preset third threshold, switching to an engine limp-home driving mode in which the vehicle operates using the engine alone.

According to another aspect, a vehicle includes an engine, a first motor and a second motor that are configured in parallel with each other, the first motor being directly connected to the engine, an inverter connected to the second motor that is connected to the engine, and a vehicle controller configurated to determine whether a failure has occurred in the second motor or the inverter, based on determination of the failure in the second motor or the inverter, switch to a limp-home mode in which the vehicle operates using the engine and the first motor, and execute at least one of a plurality of cooperative control operation schemes based on battery state information obtained from a battery management system (BMS).

Implementations according to this aspect can include one or more of the following features. For example, the failure in the second motor or the inverter can include at least one of an over-temperature failure, a position sensor failure, or a temperature sensor failure.

In some implementations, the vehicle can include a battery and a main relay. The plurality of cooperative control operation schemes can include a first-stage cooperative control operation scheme that include charging the battery by back electromotive force of the second motor based on main relay state information indicating that the main relay is turned on, comparing a charge level included in the battery state information with a preset first threshold, and executing a battery charging limit process by the BMS based on the charge level being greater than the preset first threshold.

In some implementations, overcharging of the main battery can be prevented during limp-home driving, while the main relay remains turned on and is not turned off in case of a P2 motor failure.

In some implementations, the present disclosure can enable a strategy for engine limp-home driving with more reliable and excellent performance by using the battery even in case of a P2 motor system (motor+inverter) failure.

In some implementations, the present disclosure can enable use of air conditioning and prevention of shutdown caused by low voltage in an oil pump control unit (OPU) due to voltage stability, since battery voltage can be used during engine limp-home driving.

In some implementations, the present disclosure can enhance launch-start performance since a P1 motor can be used for operation.

### BRIEF DESCRIPTION OF THE DRAWINGS

FIG. 1 is a block diagram of an example of an eco-friendly vehicle.

FIG. 2 is a control block diagram of the eco-friendly vehicle illustrated in FIG. 1.

FIG. 3 is a graph showing an example of a cooperative control operation scheme.

FIG. 4 is a flowchart showing an example of a first-stage cooperative control operation scheme.

FIG. 5 is a flowchart showing an example of a second-stage cooperative control operation scheme.

FIG. 6 is a flowchart showing an example of a third-stage cooperative control operation scheme.

### DETAILED DESCRIPTION

In describing the present disclosure, when a detailed description of a known art related to the present disclosure is determined to unnecessarily obscure the gist of the present disclosure, the detailed description thereof will be omitted herein. Various examples of the present disclosure will be described in detail below with reference to the accompanying drawings. The same reference numerals are used to indicate the same or similar components in the drawings.

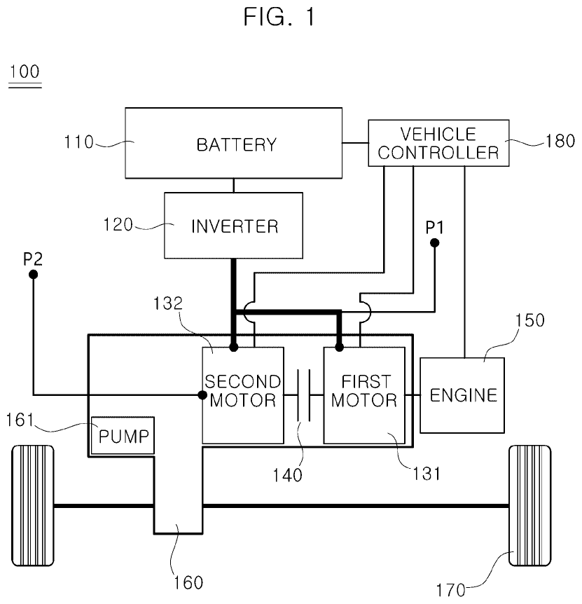

FIG. 1 is a block diagram of an example of an eco-friendly vehicle 100. Referring to FIG. 1, the eco-friendly vehicle 100 can broadly include a battery 110, an inverter 120, a first motor 131, a second motor 132, an engine clutch 140, an engine 150, a transmission 160, a wheel 170, a vehicle controller 180, and the like.

In the battery 110, battery cells can be arranged in series and/or parallel. The battery cells can be high-voltage battery cells for an electric vehicle, such as a nickel-metal battery cell, a lithium-ion battery cell, a lithium-polymer battery cell, a lithium-sulfur battery cell, a sodium-sulfur battery cell, or a solid-state battery cell. In general, a high-voltage battery refers to a battery used as a power source to move an electric vehicle and has a high voltage of 100 V or higher.

The inverter 120 performs a function of converting DC power to AC power or converting AC power to DC power. In some examples, two switching elements are connected in series above and below a central point with respect to the central point in a single phase, such that a direction of the phase current is controlled depending on whether the switching element located at the top or the switching element located at the bottom is turned on.

In some implementations, an insulated gate bipolar mode transistor (IGBT) is used as the switching element. However, the switching element is not limited thereto. For example, a field-effect transistor (FET), a metal-oxide-semiconductor FET (MOSFET), a thyristor, a gate turn-off (GTO) thyristor, a triode for alternating current (TRIAC), a silicon-controlled rectifier (SCR), or the like can also be used.

The first motor 131 (i.e., P1 motor) and the second motor 132 (i.e., P2 motor) are arranged in parallel to perform power generation and drive functions, respectively. Both the first motor 131 and the second motor 132 are connected to a crankshaft of the engine 150 and the transmission 160.

In particular, the first motor 131 is directly connected to the engine 150, and the second motor 132 is connected to the engine 150 and spaced farther apart from the engine 15 than the first motor 131. Therefore, in addition to cranking the crankshaft of the engine 150, the second motor 132 can be used as a drive motor. In some examples, the second motor 132 may not be used as a standalone drive motor, but can be coupled to the engine 150 to assist with driving force of the engine 150.

The engine clutch 140 is located between the engine 150 and the transmission 160 and serves to disengage and engage power of the engine 150. That is, the engine clutch 140 is a device that allows the power of a motor 131 and an engine 150 to be used alternately.

The engine 150 is typically an internal combustion engine (ICE).

The transmission 160 is a power transmission device that transmits power generated by the engine 150 and/or the motors 131 and 132 to the wheel 170. An electric pump 161 is configured to supply oil to the transmission 160, or to extract oil from the transmission 160.

The vehicle controller 180 performs the function of controlling the battery 110, the inverter 120, the motors 131 and 132, the engine clutch 140, the engine 150, the transmission 160, and the like. In some examples, signals and data can be sent and received. The vehicle controller 180 can include a hybrid control unit (HCU).

The eco-friendly vehicle 100 illustrated in FIG. 1 can be a vehicle to which a Transmission Mounted Electric Device (TMED)-II system is applied.

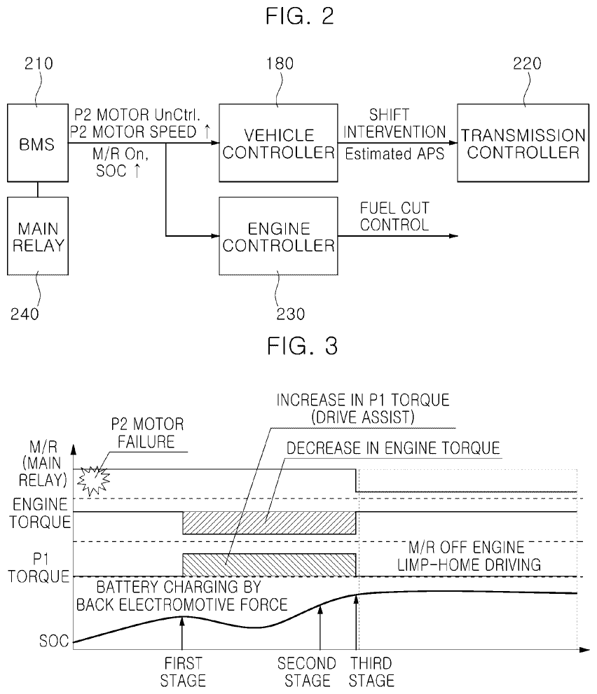

FIG. 2 is a control block diagram of the eco-friendly vehicle 100 illustrated in FIG. 1. Referring to FIG. 2, the eco-friendly vehicle 100 can include a battery management system (BMS) 210 that manages the battery 110, a transmission controller 220 that controls the transmission 160, an engine controller 230 that controls the engine 150, and the like, in addition to the vehicle controller 180.

The BMS 210 monitors battery voltage, current, and temperature in real time and prevents excessive charging and discharging, thereby enhancing the safety and reliability of the battery 110.

In some examples, the BMS 210 can be configured to include various sensors, a microprocessor, a switching element, a cell balancer, and the like. In particular, the BMS 210 generates information such as motor state information on the motors 131 and 132, battery state information on the battery 110, and relay state information on a main relay (M/R) 240, and transmits the information to the vehicle controller 180.

The motor state information can include speed, whether the motor is uncontrollable (UnCtrl), and the like. In particular, the motor state information can be on the second motor 132. For example, the motor can be determined to be uncontrollable when the motor state information has parameter UnCtrl set as True, which indicates the failure of the second motor 132.

The battery state information can primarily be state of charge (SOC), but can also include state of health (SOH), depth of discharging (DOD), state of function (SOF), and the like.

The relay state information is information indicating whether the main relay 240 is turned on or off.

The engine controller 230 generates engine speed information and transmits the information to the vehicle controller 180.

The main relay 240 is disposed between the battery 110 and the inverter 120. When turned on, the main relay 240 allows current flow between the battery 110 and the inverter 120; and when turned off, the main relay 240 blocks current flow between the battery 110 and the inverter 120.

The vehicle controller 180, the transmission controller 220, and the engine controller 230 illustrated in FIG. 2 can be configured to include a micro-computer, a microprocessor, an electronic circuit, and the like. A software configuration can also be included.

FIG. 3 is a graph showing an example of a cooperative control operation scheme. Referring to FIG. 3, when a failure is detected in the second motor 132, the on/off of the main relay 240, engine torque of the engine 150, torque of the first motor 131, and the SOC of the battery can change in stages.

For example, in case of failure not only in the second motor 132 but also in the inverter 120 that controls the second motor 132, the second motor 132 is turned off. The turning off can be achieved using a pulse width modulation (PWM) method or a pulse frequency modulation (PFM) method.

The failure of the inverter 120 can be an over-temperature failure, a position sensor failure, a temperature sensor failure, or the like.

In the first stage, the battery is charged by back electromotive force of the second motor 132; and when the battery state information increases by a preset value (%) (e.g., 3%) or higher, demand torque for a limp-home driving mode is determined, and then overcharging is prevented initially by discharging torque of the second motor 132. The limp-home driving mode is operated using the engine 150 and the first motor 131.

In the second stage, a situation where the engine speed temporarily increases due to transmission delay or the like can occur. Accordingly, if the engine speed increases by Xrpm or greater, which is a speed level of charging by the back electromotive force, the engine controller 230 executes fuel cut control to prevent the engine speed from increasing.

In the third stage, when the level of the battery state information exceeds a preset threshold (e.g., 99%), an upper-level controller secures engine startup and then transmits a request message to turn off the main relay 240 and switches to the engine limp-home mode, which operates using engine output alone.

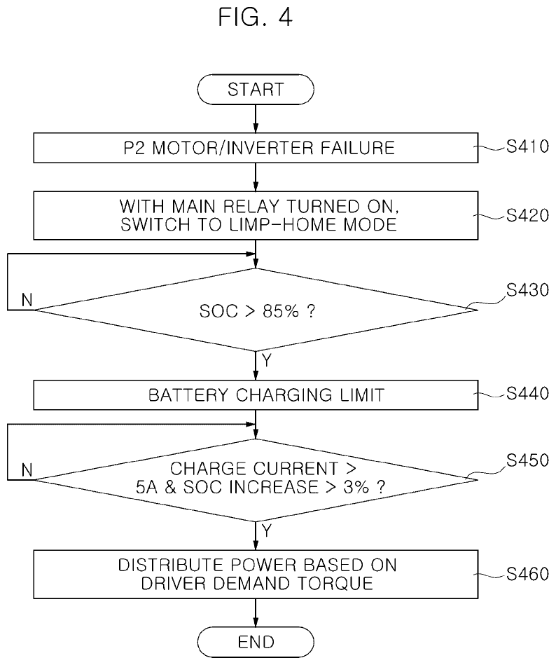

FIG. 4 is a flowchart showing an example of a first-stage cooperative control operation scheme. Referring to FIG. 4, in case of a failure in the second motor 132 or in the inverter 120 that controls the second motor 132, the vehicle controller 180 keeps the main relay 240 turned on and switches to the limp-home mode (steps S410 and S420).

In this case, the failure indicates a case where the second motor 132 or the inverter 120 that controls the second motor 132 is not capable of producing normal output. Examples of the failure can include an over-temperature failure, a position sensor failure, a temperature sensor failure, or the like.

The limp-home mode refers to a mode that uses the engine 150 and the first motor 131 for operation.

In some implementations, in case of a failure in the second motor 132 or the inverter 120 that controls the second motor 132, the second motor 132 is turned off, and the eco-friendly vehicle 100 switches to the limp-home driving mode since the second motor 132 may not be used as a drive motor.

The limp-home driving mode is a driving mode where battery charging is performed by back electromotive force of the second motor 132 while keeping the main relay 240 turned on rather than turned off by limp-home driving using the engine 150. That is, the second motor 132 can generate back electromotive force by rotating along with the engine 150.

In some examples, since the second motor 132 has been turned off and the main relay 240 remains turned on, the battery 110 can be overcharged by the back electromotive force generated by the rotation of the second motor 132. Accordingly, the driving method can be provided to prevent overcharging.

In some examples, the vehicle controller 180 obtains battery state information (e.g., SOC) from the BMS 210 and compares the information with a first threshold (e.g., 85%) (step S430).

In step S430, if the comparison result shows that the SOC is less than or equal to 85%, step S430 is repeated.

In some examples, in step S430, if the comparison result shows that the SOC is greater than 85%, battery charging limit is executed (step S440). For example, if SOC balancing control is not possible and the SOC is greater than 85%, the BMS 210 executes battery charging limit to prevent further charging. The above SOC level is an example, and the SOC level can vary depending on the vehicle or battery state.

Controllers that have received a battery charging limit signal from the BMS 210 no longer execute charging, such as regenerative charging.

Then, if charging continues despite the charging limit of the BMS 210, it can be due to back electromotive force. To determine whether the continued charging is due to back electromotive force, the vehicle controller 180 determines whether the charging current generated is greater than a reference current (e.g., 5 A), and whether the increase in the SOC is greater than a preset value (%) (e.g., 3%) (step S450).

In step S450, if the determination result shows that the above conditions are not satisfied, step S450 is repeated.

In some examples, in step S450, if the determination result shows that the above conditions are satisfied, the vehicle controller 180 distributes power based on driver demand torque (step S460). For example, if a charging current of 5 A or more is generated and the SOC continues to increase (an increase of more than 3%), demand torque of the limp-home driving is determined. Then, torque of the first motor 131 is used up to its full capacity, and torque of the engine 150 is used to fill the remaining demand torque. Overcharging can be initially prevented by the discharging torque of the first motor 131.

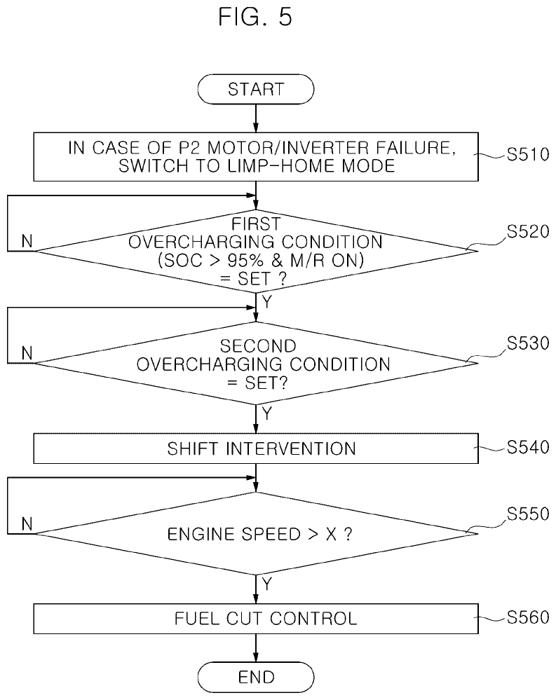

FIG. 5 is a flowchart showing an example of a second-stage cooperative control operation scheme. For example, despite implementing the first-stage cooperative control operation scheme, the SOC continues to increase and reaches a high SOC of approximately 95%, and the main relay 240 remains turned on, and thus there is a possibility that the battery 110 can be further overcharged. Accordingly, the second-stage cooperative control operation scheme is performed.

Referring to FIG. 5, in case of a failure in the second motor 132 or in the inverter 120 that controls the second motor 132, the vehicle controller 180 turns off the second motor 132, keeps the main relay 240 turned on, and switches to the limp-home mode (step S510).

Then, the vehicle controller 180 determines whether a first overcharging condition is satisfied (step S520). For example, the first overcharging condition is satisfied if the SOC is greater than a second threshold (e.g., 95%), which is a level higher than the level of the first-stage cooperative control scheme, and the main relay 240 is turned on. In some examples, the SOC level can vary depending on the type and state of the vehicle or battery.

In step S520, if the battery state information is less than or equal to 95% or if the main relay 240 does not remain turned on, step S520 is repeated.

In some examples, in step S520, if the battery state information is greater than 95% and the main relay 240 remains turned on, the vehicle controller 180 determines whether a second overcharging condition is satisfied (step S530). For example, the second overcharging condition is satisfied if the second motor 132 is uncontrollable (UnCtrl). The vehicle controller 180, which is an upper-level controller that performs cooperative control, is in CAN communication with a micro control unit (MCU) of the BMS 210. Therefore, it is possible to determine, by referring to a controllable signal of the MCU, whether the second overcharging condition is satisfied.

If the second motor 132 is uncontrollable by pulse width modulation (PWM), the back electromotive force of the second motor 132 can directly flow into the battery 110, thereby potentially causing more severe overcharging. Accordingly, if both the first and the second overcharging conditions are satisfied, overcharging can be prevented by performing shift intervention.

In step S530, if the determination result shows that the second overcharging condition is not satisfied, step S530 is repeated.

In some examples, in step S530, if the determination result shows that the second overcharging condition is satisfied, the vehicle controller 180 performs shift intervention control (step S540). In the shift intervention control, the vehicle controller 180 sends an estimated accelerator position sensor (APS) signal to the transmission controller 220. In this case, the estimated APS signal is an APS signal that is limited to up to 20-30%.

Accordingly, no matter how much a driver presses the APS, kick down does not occur; and thus the engine speed does not increase rapidly, and the engine speed does not increase through smooth upshift. If the engine speed does not increase, the speed of the second motor 132, which is connected to the engine clutch 140, also does not increase; and thus battery charging by back electromotive force does not occur.

In some implementations, to prevent an increase in revolutions per minute (RPM), in addition to a method of sending an estimated APS signal, methods such as prohibiting manual shift (i.e., manual shift by a driver) and prohibiting downshift during APS input can also be used. These methods prevent an RPM increase caused by downshifting to a lower gear stage.

In some examples, a situation can occur where the engine speed temporarily increases, based on the engine speed information obtained from the engine controller 230, due to transmission delay or the like; and thus it is determined whether the engine speed increases above a speed threshold (Xrpm), which is a speed level of charging by back electromotive force (step S550).

In step S550, if the determination result shows that the engine speed is lower than or equal to the speed threshold, step S550 is repeated.

In some examples, in step S550, if the determination result shows that the engine speed is greater than the speed threshold, fuel cut control is performed (step S560). That is, the fuel supply to the engine 150 is cut off. Accordingly, the engine speed is prevented from increasing.

In FIG. 5, both the shift intervention control and the fuel cut control are illustrated as being executed, but it is possible to execute the shift intervention control or the fuel cut control independently. That is, after step S530, the shift intervention control or the fuel cut control can be selectively executed. Accordingly, in the fuel cut control, steps S550 and S560 can be performed immediately after step S530.

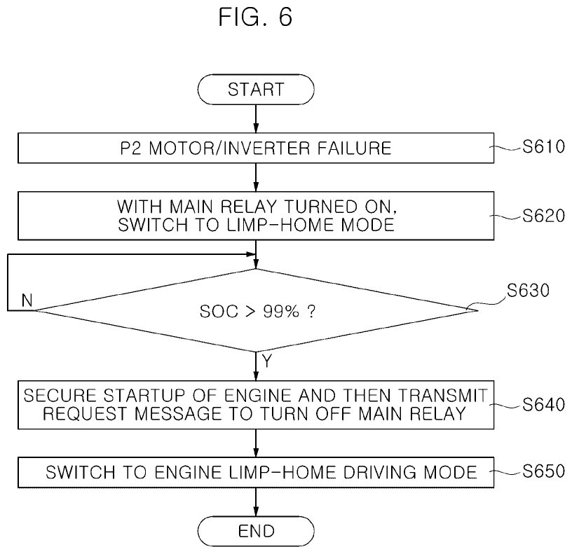

FIG. 6 is a flowchart showing an example of a third-stage cooperative control operation scheme. Referring to FIG. 6, in case of a failure in the second motor 132 or in the inverter 120 that controls the second motor 132, the vehicle controller 180 keeps the main relay 240 turned on and switches to the limp-home mode (steps S610 and S620).

The vehicle controller 180 compares battery state information (e.g., SOC) obtained from the BMS 210 with a third threshold (e.g., 99%) (step S630).

In step S630, if the comparison result shows that the SOC is less than or equal to 99%, step S630 is repeated.

In some examples, in step S630, if the comparison result shows that the SOC is greater than 99%, the vehicle controller 180 secures startup of the engine 150 and then transmits, to the BMS 210, a request message to turn off the main relay 240 (step S640). Securing of the startup of the engine 150 is achieved using the first motor 131.

Then, the vehicle controller 180 switches to the engine limp-home driving mode that operates using engine output alone (step S650).

The first-to third-stage cooperative control operation schemes illustrated in FIGS. 4 to 6 can each be selected and executed independently, or at least two of the schemes can be selected and executed sequentially.

If an uncontrollable signal is received from the first motor 131, the first-stage cooperative control can become impossible, and the second step cooperative control operation algorithm described above can be performed in the same manner. For example, if the first motor 131 is uncontrollable, back electromotive force flows into the battery 110, where an overcharge prevention cooperative control can be provided. In some examples, the second-stage cooperative control operation algorithm and/or the third-stage cooperative control operation algorithm can be performed in a modified manner. In some implementations, the second-stage cooperative control operation algorithm and the third-stage cooperative control operation algorithm can be selected and executed sequentially.

For example, the second-stage cooperative control operation scheme includes: charging the battery 110 by the back electromotive force of the first motor 131; and determining whether a first overcharging condition is satisfied using battery state information and state information of the main relay 240; if the first overcharging condition is satisfied, determining whether a second overcharging condition in which the first motor 131 among the plurality of the motors is uncontrollable is satisfied; and if the second overcharging condition is satisfied, performing, by the vehicle controller 180, shift intervention.

In addition, the steps of the methods or algorithms described in connection with the implementations disclosed herein can be implemented in the form of program instructions that can be executed by various computing devices, such as a microprocessor, a processor, and a central processing unit (CPU), and recorded on a computer-readable medium. The computer-readable medium can include program (instruction) code, a data file, a data structure, and the like, either alone or in a combination thereof.

What is claimed is:

1. A driving method for a vehicle in a motor failure, the vehicle including first and second motors that are arranged in parallel with each other, the driving method comprising:
determining, by a vehicle controller, whether a failure has occurred in the second motor or in an inverter connected to the second motor;
based on a determination of the failure in the second motor or the inverter, switching, by the vehicle controller, to a limp-home mode in which the vehicle operates using an engine of the vehicle and the first motor that is directly connected to the engine; and
executing, by the vehicle controller, at least one of a plurality of cooperative control operation schemes based on battery state information obtained from a battery management system (BMS).

2. The driving method of claim 1, wherein the battery state information comprises at least one of a state of charge (SOC), a state of health (SOH), a depth of discharging (DOD), or a state of function (SOF).

3. The driving method of claim 1, wherein the failure in the second motor or the inverter comprises at least one of an over-temperature failure, a position sensor failure, or a temperature sensor failure.

4. The driving method of claim 1, wherein the plurality of cooperative control operation schemes comprise a first-stage cooperative control operation scheme that comprises:
charging a battery of the vehicle by back electromotive force of the second motor based on main relay state information indicating that a main relay of the vehicle is turned on;
comparing a charge level included in the battery state information with a preset first threshold; and
based on the charge level being greater than the preset first threshold, executing, by the BMS, a battery charging limit process.

5. The driving method of claim 4, wherein the first-stage cooperative control operation scheme further comprises:
after executing the battery charging limit process, determining, by the vehicle controller, (i) whether a charging current is greater than a preset reference current and (ii) whether an increase of the charge level in the battery state information is greater than a preset increment value; and
based on determining that the charging current is greater than the preset reference current and that the increase of the charge level is greater than the preset increment value, distributing, by the vehicle controller, power to the first motor and the engine according to a driver demand torque.

6. The driving method of claim 5, wherein distributing the power to the first motor and the engine comprises:
providing (i) a first portion of the power to the first motor to operate the first motor with a maximum torque that is set to prevent overcharging of the battery and (ii) a second portion of the power to the engine to operate the engine with a supplemental torque to thereby provide a remainder of the driver demand torque.

7. The driving method of claim 1, wherein the plurality of cooperative control operation schemes comprise a second-stage cooperative control operation scheme that comprises:
charging a battery of the vehicle by back electromotive force of the second motor;
determining whether a first overcharging condition is satisfied based on the battery state information and main relay state information of a main relay of the vehicle;
based on determining that the first overcharging condition is satisfied, determining whether a second overcharging condition is satisfied based on motor state information indicating that the second motor is uncontrollable; and
based on determining that the second overcharging condition is satisfied, performing, by the vehicle controller, at least one of a shift intervention control or a fuel cut control.

8. The driving method of claim 7, wherein the first overcharging condition is satisfied based on (i) a charge level included in the battery state information being greater than a preset second threshold and (ii) the main relay being turned on.

9. The driving method of claim 7, wherein the shift intervention control comprises transmitting, by the vehicle controller, an estimated accelerator position sensor (APS) signal to a transmission controller.

10. The driving method of claim 9, wherein the estimated APS signal is set 20-30% of a reference APS signal corresponding to a maximum accelerator position.

11. The driving method of claim 7, wherein the fuel cut control comprises:
determining, by the vehicle controller, whether an engine speed obtained from an engine controller is greater than a preset speed threshold; and
based on determining that the engine speed is greater than the preset speed threshold, performing, by the engine controller, the fuel cut control.

12. The driving method of claim 1, wherein the plurality of cooperative control operation schemes comprise a third-stage cooperative control operation scheme that comprises:
charging a battery of the vehicle by back electromotive force of the second motor based on main relay state information indicating that a main relay of the vehicle is turned on;
comparing a charge level included in the battery state information with a preset third threshold; and
based on the charge level being greater than the preset third threshold, switching to an engine limp-home driving mode in which the vehicle operates using the engine alone.

13. The driving method of claim 12, wherein switching to the engine limp-home driving mode comprises:
performing, by the vehicle controller, a startup of the engine, and then transmitting, by the vehicle controller, to the BMS, a request message to turn off the main relay.

14. The driving method of claim 13, wherein the startup of the engine is performed using the first motor.

15. A driving method of a vehicle in a motor failure, the vehicle including first and second motors that are arranged in parallel with each other, the driving method comprising:
determining, by a vehicle controller, whether a failure has occurred in the first motor or in an inverter connected to the first motor;
based on determination of the failure in the first motor or the inverter, switching, by the vehicle controller, to a limp-home mode in which the vehicle operates using an engine of the vehicle and the second motor, wherein the second motor is connected to the engine and located farther from the engine than the first motor is; and
executing, by the vehicle controller, at least one of a second-stage cooperative control operation scheme or a third-stage cooperative control operation scheme based on battery state information obtained from a battery management system (BMS).

16. The driving method of claim 15, wherein the second-stage cooperative control operation scheme comprises:
charging a battery of the vehicle by back electromotive force of the first motor;
determining whether a first overcharging condition is satisfied based on the battery state information and main relay state information of a main relay of the vehicle;
based on determining that the first overcharging condition is satisfied, determining whether a second overcharging condition is satisfied based on motor state information indicating that the first motor is uncontrollable; and
based on determining that the second overcharging condition is satisfied, performing, by the vehicle controller, a shift intervention control.

17. The driving method of claim 15, wherein the third-stage cooperative control operation scheme comprises:
charging a battery of the vehicle by back electromotive force of the first motor based on main relay state information indicating that a main relay of the vehicle is turned on;
comparing a charge level included in the battery state information with a preset third threshold; and
based on the charge level being greater than the preset third threshold, switching to an engine limp-home driving mode in which the vehicle operates using the engine alone.

18. A vehicle comprising:
an engine;
a first motor and a second motor that are configured in parallel with each other, the first motor being directly connected to the engine;
an inverter connected to the second motor that is connected to the engine; and
a vehicle controller configurated to:
determine whether a failure has occurred in the second motor or the inverter,
based on determination of the failure in the second motor or the inverter, switch to a limp-home mode in which the vehicle operates using the engine and the first motor, and
execute at least one of a plurality of cooperative control operation schemes based on battery state information obtained from a battery management system (BMS).

19. The vehicle of claim 18, wherein the failure in the second motor or the inverter comprises at least one of an over-temperature failure, a position sensor failure, or a temperature sensor failure.

20. The vehicle of claim 18, further comprising a battery and a main relay,
wherein the plurality of cooperative control operation schemes comprise a first-stage cooperative control operation scheme that comprises:
charging the battery by back electromotive force of the second motor based on main relay state information indicating that the main relay is turned on;
comparing a charge level included in the battery state information with a preset first threshold; and
executing a battery charging limit process by the BMS based on the charge level being greater than the preset first threshold.
